(19) United States
(12) Patent Application Publication
(10) Pub. No.: US 2007/0015875 A1
(43) Pub. Date: Jan. 18, 2007

(54) Foamed article comprising filled perfluoropolymer composition

(76) Inventors: Yevgeniy I. Globus, Littleton, MA (US); Mark A. Jozokos, Pelham, NH (US); John L. Netta, Newark, DE (US); George Martin Pruce, Glastonbury, CT (US); Sundar Kilnagar Venkataraman, Avondale, PA (US); Heidi Elizabeth Burch, Parkersburg, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/485,398

(22) Filed: Jul. 12, 2006

Related U.S. Application Data
(60) Provisional application No. 60/700,168, filed on Jul. 18, 2005.

(51) Int. Cl. C08L 27/12

(52) U.S. Cl. 525/199

(57) ABSTRACT

The present invention relates to foamed articles, such as plenum cables jacketed with a composition comprising perfluoropolymer, inorganic char-forming agent, and polymeric dispersing agent, which passes the NFPA-255 burn test.

### BACKGROUND OF THE INVENTION

1. Field of the Invention

This invention relates to foamed articles of filled compositions of perfluoropolymer.

2. Description of Related Art

Plenum cable is cable used for data and voice transmission that is installed in building plenums, i.e. the spaces above dropped ceilings or below raised floors that are used to return air to conditioning equipment. The cable comprises a core which performs the transmission function and a jacket over the core. Typical core constructions include a plurality of twisted pairs of insulated wires or coaxially-positioned insulated conductors.

Cable jackets of polyvinyl chloride (PVC) and flame retardant additives are known for plenum cable, but the resultant compositions do not pass the National Fire Protection Association (NFPA)-255 burn test (Surface Burning of Building Materials), which requires non-flammability and low-to-no smoke emission. UL 2424, Appendix A, provides that cables tested in accordance with NFPA-255 must have a smoke developed index (hereinafter Smoke Index) of no greater than 50 and a flame spread index (Flame Spread Index) of no greater than 25. Heretofore, these attributes of plenum cable jackets have been evaluated by UL-910 (NFPA-262—Standard Method of Test for Flame Travel and Smoke of Wires and cables for Use in Air-Handling Spaces), but as concerns about fire safety have risen, it has been found that cable jackets of PVC composition that pass the NFPA-262 test do not pass the more severe NFPA-255 test.

Cable jackets of tetrafluoroethylene/hexafluoropropylene (FEP) copolymer are also known for plenum cable that do pass the NFPA-255 burn test. Such FEP has a melt flow rate (MFR) of 2-7 g/10 min, which means that it has a high melt viscosity. Because of this high melt viscosity, this FEP has the disadvantage of high production cost cable jacket, because this FEP is only capable of being extruded at a rate (line speed) of up to about 120 ft/min. Higher MFR (lower melt viscosity) FEP has been tried as cable jacket, but such jacket does not pass the NFPA-255 test. As the MFR increases above 7 g/10 min, the resultant lower melt viscosity of the FEP causes it to drip and smoke, resulting in a Smoke Index of greater than 50. It is noteworthy that this FEP is not flammable, i.e. it simply melts and drips and does not form a carbonaceous char. The same is true with other high MFR melt-fabricable perfluoropolymers.

### BRIEF SUMMARY OF THE INVENTION

The present invention satisfies the need for a foamed article that is sufficiently non-flammable, non-dripping, and non-smoke emitting during exposure to fire that the composition passes the NFPA-255 burn test, i.e. has a Smoke Index of no greater than 50 and Flame Spread Index of no greater than 25. This foamed article comprises perfluoropolymer, about 10-60 wt % char-forming inorganic agent, and about 0.1 to 5 wt % polymeric dispersing agent. The polymeric dispersing agent may be a hydrocarbon polymer additive or a low melting fluoropolymer additive (fluoropolymer additive). The foamed article is thermally stable at the melting temperature of said perfluoropolymer, to total 100 wt % based on the combined weight of said perfluoropolymer, agent and polymeric dispersing agent. This foamed article as a melt-extruded article, passes the NFPA-255 burn test.

Foamed articles of the perfluoropolymers used in the present invention do not, by themselves, pass the NFPA-255 burn test. The combination of just the char-forming inorganic agent and the perfluoropolymer tends to improve the performance of the foamed article in the burn test, but, typical of highly filled polymer, the physical properties of the foamed article are not satisfactory for the desired end use, such as wire insulation. The polymeric dispersing agent is necessary to obtain a foamed article that both passes the NFPA-255 burn test and has good physical properties. As one skilled in the art will recognize, the ability of the foamed article of the present invention to pass the NFPA-255 burn test is demonstrated by submitting the melt-fabricated foamed article in the form of a wire insulation to the burn test. In this regard, the foamed article of the present invention is especially useful as a cable jacket for plenum cable, the jacket being formed by extrusion over and onto the core of the cable. The jacket of the foamed article of the present invention can be considered to pass the NFPA-255 burn test when the entire cable is subjected to the test and passes the test. This is confirmed by substituting a jacket such as a foamed polyvinyl chloride composition over the same cable core, such cable failing the burn test because the jacket does not pass this test. Thus, it is clear that when the jacket of the foamed article of the present invention is responsible for the cable passing the test, the jacket itself can be considered to pass the burn test.

Because of the rigor of the NFPA 255 burn test, it is critical that the foamed article does not contain ingredients that promote burning. Thus, the composition should be free of ingredients that degrade during melt processing. When the polymeric dispersing agent is hydrocarbon polymer, antioxidant may be present in the hydrocarbon polymer as-supplied, and this small amount of antioxidant, if present, seems harmless. Antioxidant that would otherwise be added to a composition containing the polymeric dispersing agent to protect it during melt processing should not be so-added to the foamed article of the present invention. The same is true for other additives; for example, plasticizers should not be present in the foamed article of the present invention.

The exception to the use of flammable ingredients in the composition of the present invention is the hydrocarbon polymer when hydrocarbon polymer is used as polymeric dispersing agent, which because of its hydrocarbon nature, is flammable and therefore flame spreading and smoke producing. The NFPA-255 burn test applied to plenum cable involves exposing multiple lengths of the jacketed cable to burning, e.g. the common cable that contains four twisted pairs of insulated conductors will typically require more than 100 lengths of such cable laid side-by-side for exposure to burning. These 100+ lengths of cable, each jacket being a foamed article according to the present invention, provides a substantial amount of fuel when the polymeric dispersing agent is hydrocarbon polymer, being present in the burn test furnace. Surprisingly, as cable jacket, the foamed article of the present invention, notwithstanding the presence of the hydrocarbon polymer (when that is the polymeric dispersing agent), passes the NFPA-255 burn test, both with respect to lack of flame spreading and to creation of smoke. When the polymeric dispersing agent is a fluoropolymer additive, it makes little or no contribution as fuel to the composition.

Moreover, one would expect that the substantial amount of char-forming agent in the composition of the present invention would lead to local gassing and bubbling and an irregular foam with voids and holes. It is surprising that the filled composition of this type, with the substantial loading of char forming agent, can be foamed so readily to give a uniform and well-formed foam.

Advantageously, foamed articles according to the present invention have a reduction in density of greater than about 10% as compared to an unfoamed article.

### DETAILED DESCRIPTION OF THE INVENTION

In accordance with the present invention, there is provided a foamed, melt-fabricated article containing a composition comprising perfluoropolymer, about 10-60 wt % char-forming inorganic agent, and an effective amount of polymeric dispersing agent to disperse the char-forming agent in the perfluoropolymer during melt-processing. In one embodiment, hereinafter referred to as the hydrocarbon polymer embodiment, the polymeric dispersing agent is a hydrocarbon polymer. In another embodiment, hereinafter referred to as the fluoropolymer additive embodiment, the polymeric dispersing agent is a low melting fluoropolymer additive.

The perfluoropolymers used in the foamed article of the present invention are those that are melt-fabricable, i.e. they are sufficiently flowable in the molten state that they can be fabricated by melt processing such as extrusion, to produce products having sufficient strength so as to be useful. The melt flow rate (MFR) of the perfluoropolymers used in the present invention is relatively high, preferably at least about 10 g/10 min, more preferably at least about 15 g/10 min, even more preferably at least about 20 g/10 min, and most preferably, at least 26 g/10 min, as measured according to ASTM D-1238 at the temperature which is standard for the resin (see for example ASTM D 2116-91a and ASTM D 3307-93). The relatively high MFR of the perfluoropolymers prevents them by themselves from passing the NFPA-255 burn test. As indicated by the prefix “per”, the monovalent atoms bonded to the carbon atoms making up the polymer are all fluorine atoms. Other atoms may be present in the polymer end groups, i.e. the groups that terminate the polymer chain. Examples of perfluoropolymers that can be used in the composition of the present invention include the copolymers of tetrafluoroethylene (TFE) with one or more perfluorinated polymerizable comonomers, such as perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, respectively known as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/perfluoro(methyl vinyl ether)/perfluoro(propyl vinyl ether) copolymer, sometimes called MFA by the manufacturer. The preferred perfluoropolymers are TFE/HFP copolymer in which the HFP content is about 9-17 wt %, more preferably TFE/HFP/PAVE such as PEVE or PPVE, wherein the HFP content is about 9-17 wt % and the PAVE content, preferably PEVE, is about 0.2 to 3 wt %, to total 100 wt % for the copolymer. These polymers are commonly known as FEP. TFE/PAVE copolymers, generally known as PFA, have at least about 1 wt % PAVE, including when the PAVE is PPVE or PEVE, and will typically contain about 1-15 wt % PAVE. When PAVE includes PMVE, the composition is about 0.5-13 wt % perfluoro(methyl vinyl ether) and about 0.5 to 3 wt % PPVE, the remainder to total 100 wt % being TFE, and as stated above, may be referred to as MFA.

The inorganic char-forming agent is comprised of at least one inorganic compound that forms, including promoting the formation of, a char in the NFPA-255 burn test. In the burn test, the agent does not prevent the perfluoropolymer from burning, because the fluoropolymer is not flammable. By not flammable is meant that the fluoropolymer does not burn in the NFPA-255 burn test, whereby it has a Flame Spread Index of no greater than 25. Instead, the char-forming agent contributes to formation of a char structure that prevents the total composition from dripping, which would lead to objectionable smoke formation and failure of the burn test. It is unexpected that char-forming agent would have any utility when used with non-flammable perfluoropolymer. Although the perfluoropolymer does not burn, it appears that the char-forming agent interacts with the perfluoropolymer during the burn test to prevent the high MFR perfluoropolymer from dripping, whereby the creation of smoke is suppressed. Although the combination of the perfluoropolymer and char-forming agent is melt flowable (extrudable), which suggests that the composition would drip when subjected to burning, the composition does not drip. The char-forming agent thus appears to act as a thixotropic agent in the article of the composition being subjected to burn. This thixotropic effect can be quantified by rheology (oscillatory shear) measurement using an ARES® Dynamic Rheometer as shown in the following Table 1.

TABLE 1
Variation of FEP Viscosity with Shear at 340° C.

| | Complex Viscosity (Pa · s) | | | | | |
|---|---|---|---|---|---|---|
| Shear | FEP | FEP | | | Viton ® | Kalrez ® |
| (rad/s) | (MFR 30) | (MFR 7) | Composition | Viton ® VTX | A HV | K2000 |
| 100 | 1106 | 2810 | 4919 | 4421 | 1960 | 4266 |
| 10 | 1601 | 6202 | 12673 | 9541 | 3839 | 11752 |
| 1 | 1766 | 7970 | 46186 | 19252 | 5859 | 31521 |
| 0.1 | 1860 | 8691 | 262000 | 55232 | 9774 | 145000 |

In the Table the MFRs are in units of g/10 min, and the Composition is the composition of Example 1. The Table shows that the increase in viscosity (complex viscosity) with reduced shear rate is about 3× for the 7 MFR FEP, about 1.6× for the 30 MFR FEP, and about 53× for the composition as the shear rate decreases from 100 rad/s to 0.1 rad/s. The shear rate of 0.1 rad/s is an approximation of the shear condition to which the article melt-fabricated from the hydrocarbon polymer composition of the present invention is exposed in applications that may be exposed to fire. The extremely high viscosity of the composition at 0.1 rads/s explains the suppression of dripping of the composition of the present invention. As the shear is increased to the shear that is characteristic of melt fabrication by extrusion, the melt viscosity of the composition decreases to be similar to that of the MFR 30 FEP at the same shear rate.

While the suppression of dripping and therefore suppression of smoke is one manifestation of the char-forming agent used in the present invention, the formation of char is the effect that is visible in the aftermath of the NFPA-255 burn test. Instead of the jacket having the appearance of a misshapen solidified melt, the jacket has the appearance ranging from an intact, unaffected jacket, to areas wherein the jacket exhibits fractures, to areas wherein the jacket is fractured into flakes, and to areas wherein the flakes have fallen off the cable. The fractured portions of the jacket and the flakes thereof can be considered a char in the sense of being a residue of the “burned” jacket. This char however, is not black as would be characteristic if the char were carbonaceous. The C—F chemical bonds of the perfluoropolymer are so strong that the polymer is well known to form volatile fluorocarbon compounds when subjected to burning rather than to decompose to leave a carbon residue. Even if the flakes fall away from the cable, they do not cause smoke such that the cable would fail the NFPA-255 burn test. Plenum cable jacketed with the foamed article of the present invention passes this test.

The char-forming agent is thermally stable and non-reactive at the melt processing temperature of the foamed article, in the sense that it, in itself, does not cause discoloration or foaming of the composition, which would indicate the presence of degradation or reaction. The agent itself has color, typically white, which provides the color of the melt processed composition. In the burn test however, the formation of char indicates the presence of degradation.

The foamed article of the present invention is highly filled, the char-forming agent constituting at least about 10 wt % of the composition (total weight of perfluoropolymer, agent, plus polymeric dispersing agent). The amount of agent necessary to form sufficient char will depend on the agent, the particular perfluoropolymer used and its MFR. Some agents are more effective than others, whereby a relatively small amount will suffice for the foamed article as wire insulation or cable jacket to pass the NFPA-255 burn test. Generally, sufficient char can be obtained when the foamed article contains about 20 to 50 wt % of the inorganic char-forming agent. Examples of char-forming agents are zinc molybdate, calcium molybdate, and metal oxides such as ZnO, Al₂O₃, TiO₂, and MgZnO₂. Preferably the mean particle size of the char-forming agent is no greater than about 3 μm, and more preferably, no greater than about 1 μm, to provide the best physical properties for the foamed article. Another example of inorganic char-forming agent is ceramic microspheres, such as Zeeospheres® ceramic microspheres available from the 3M Company, which are understood to be alkali alumina silicates, which may have a larger mean particle size than about 3 μm, e.g. as large as about 5 μm, with smaller particle sizes, such as no greater than about 3 μm mean particle size being preferred. Preferably, the mean minimum particle size is at least about 0.05 μm; smaller particle sizes tend to embrittle or overly harden the foamed article. In one embodiment of the present invention, the inorganic char forming agent comprises a plurality of char-forming agents. In another embodiment of the present invention, at least one of this plurality of char-forming agents is ceramic microspheres. A preferred foamed article comprises about 5 to 20 wt % ceramic microspheres and about 20-40 wt % of another char-forming agent, preferably ZnO, to constitute about 10-60 wt % of the char-forming agent(s) component of the composition of the present invention.

The polymeric dispersing agent is used in an amount that is effective to provide the physical properties desired. The polymeric dispersing agent itself does not provide the improved physical properties. Instead, the polymeric dispersing agent interacts with the char-forming agent and perfluoropolymer to limit the reduction in tensile properties that the agent if used by itself would have on the perfluoropolymer composition. Without the presence of the polymeric dispersing agent, the melt blend of the perfluoropolymer/char-forming agent tends to be cheesy in appearance, i.e. to lack integrity, e.g. showing cracks and containing loose, unincorporated agent. With the polymeric dispersing agent being present, a uniform-appearing melt blend is obtained, in which the entire char-forming agent is incorporated into the melt blend. Thus, the hydrocarbon polymer and the fluoropolymer additive act as a dispersing agent for the char-forming agent, which is surprising in view of the incompatibility of the perfluoropolymer and polymeric dispersing agent. Hydrocarbon polymer does not adhere to perfluoropolymer. Neither does the char-forming agent. Nor are different fluoropolymers usually compatible. In the fluoropolymer additive embodiment, the char-forming agent does not adhere to the perfluoropolymer, and yet, surprisingly, the fluoropolymer additive acts as a dispersing agent for the char-forming agent in the perfluoropolymer. Nevertheless and surprisingly, the polymeric dispersing agent acts as a dispersing agent for the char-forming agent. The effectiveness of the dispersion effect of the polymeric dispersing agent can be characterized by the tensile test specimen of the composition used in making the foamed article of the present invention exhibiting an elongation of at least about 100%, preferably at least about 150%. The specimen also preferably exhibits a tensile strength of at least about 1500 psi (10.3 MPa). Preferably these properties are achieved on cable jacket specimens in accordance with ASTM D 3032 under the operating conditions of the tensile testing jaws being 2 in (5.1 cm) apart and moving apart at the rate of 20 in/min (51 cm/min).

A wide variety of polymeric dispersing agents, and in the hydrocarbon polymer embodiment, hydrocarbon polymers that are thermally stable at the melt temperature of the perfluoropolymer, provide this benefit to the foamed article. The thermal stability of the hydrocarbon polymer is visualized from the appearance of the melt blend of the foamed article, that it is not discolored by degraded hydrocarbon polymer. Since perfluoropolymers melt at temperatures of at least about 250° C., the hydrocarbon polymer should be thermally stable at least up to this temperature and up to the higher melt processing temperature, which will depend on the melting temperature of the particular perfluoropolymer being used and the residence time in melt processing. Such thermally stable polymers can be semicrystalline or amorphous, and can contain aromatic groups either in the polymer chain or as pendant groups. Examples of such polymers include polyolefins such as the linear and branched polyethylenes, including high density polyethylene and Engage® polyolefin thermoplastic elastomer and polypropylene. Additional polymers include siloxane/polyetherimide block copolymer. Examples of aromatic hydrocarbon polymers include polystyrene, polycarbonate, polyethersulfone, and polyphenylene oxide, wherein the aromatic moiety is in the polymer chain. The preferred polymer is the thermoplastic elastomer, which is a block copolymer of olefin units and units containing an aromatic group, commonly available as Kraton® thermoplastic elastomer. Most preferred are the Kraton® G1651 and G1652 that are styrene/ethylene/butylene/styrene block copolymers containing at least 25 wt % styrene-derived units. The hydrocarbon polymer should have a melting temperature or be melt flowable in the case of amorphous hydrocarbon polymers so as to be melt-blendable with the other ingredients that go into the foamed article.

When the polymeric dispersing agent according to this invention is a low melting fluoropolymer additive (fluoropolymer additive), that term means a fluoropolymer having a melting point, or if having no melting point, i.e. being amorphous, having a glass transition temperature (Tg), at least about 10° C. below that of the perfluoropolymer that makes up the greatest part of the composition. It is preferable that the melting point, or in the absence of the melting point, the Tg of the fluoropolymer additive be at least about 25° C. lower, more preferably at least about 50° C. lower, still more preferably at least about 100° C. lower, even more preferably at least about 150° C. lower, and most preferably at least about 200° C. lower, than that of the perfluoropolymer that makes up the greatest part of the composition. It is further preferable that the fluoropolymer additive be amorphous, and more preferable still that the fluoropolymer additive be a fluoroelastomer.

By amorphous is meant that any detectable melting endotherm has a heat of fusion no greater than about 5 J/g as measured by differential scanning calorimetry, preferably less than about 3 J/g, more preferably less than about 1 J/g, most preferably no detectable heat of fusion. The measurement is the “first heat”, that is the measurement is made on the polymer that has not previously been heated for melt processing, or to temperatures above about 125° C. Determination of heats of fusion is done according to ASTM D-3418-03.

As used herein, fluoroelastomer is amorphous and has a glass transition temperature (Tg) at or below about room temperature (20° C.), preferably below 10° C. It is understood that in some applications fluoroelastomer is crosslinked, usually as the final step in processing, after molding or otherwise being shaped. According to this invention, it is not preferred that the fluoroelastomer be crosslinked, or that crosslinking agents or curing agents be included.

Fluoropolymer additive as defined here includes thermoplastic fluoroelastomer, as for example the thermoplastic fluoroelastomer described in U.S. Pat. No. 6,153,681. Thermoplastic fluoroelastomer has elastomeric and thermoplastic segments (sometimes called soft and hard segments) in the polymer chain. The elastomeric segments have the properties of Tg and heat of fusion as described in the preceding paragraph. Thermoplastic fluoroelastomer spontaneously crosslinks on cooling through the association or cocrystallization (in which case the thermoplastic elastomer has a melting point) of the thermoplastic segments, which thereby act as crosslinking sites, tying the polymer chains together. The melting point or Tg of thermoplastic elastomer elastomeric segments of the fluoropolymer additive according to this invention will be below that of the perfluoropolymer that makes up the major part of the composition, apart from the char-forming agent.

The fluorine content of the fluoropolymer additive should be at least about 35 wt %, preferably at least about 40 wt %, more preferably at least about 45 wt %, still more preferably at least about 50 wt % and most preferably at least about 60 wt %.

Examples of suitable fluoropolymer additives according to this invention include ethylene/tetrafluoroethylene (ETFE) copolymers described in U.S. Pat. No. 6,197,904, which have melting points around 200° C. Examples also include tetrafluoroethylene/hexafluoropropylene copolymers such as those described in U.S. Pat. Nos. 5,547,761, 5,708,131, and 6,468,280. Examples further include tetrafluoroethylene/perfluoro(alkyl vinyl ether) copolymers such as are described in U.S. Pat. No. 5,919,878.

Fluoroelastomers suitable for use as fluoropolymer additives according to the present invention are described in Ullmann's Encyclopedia of Industrial Chemistry, Vol. A 11, pp. 417-420, VCH Verlagsgesellschaft mbH, D6940, Weinheim, Germany, 1988.

One type of fluoroelastomer suitable for use with the present invention is a dipolymer of vinylidene fluoride (VDF) and hexafluoropropene (HFP). This elastomer is sold under the trademark Viton® A HV by DuPont Performance Elastomers. Another type of vinylidene fluoride based elastomer suitable for use with the present invention is the TFE-containing terpolymer, VDF/HFP/TFE copolymer (also known as THV elastomer), sold under the trademark Viton® B by DuPont Performance Elastomers. This terpolymer is even more thermally stable and solvent resistant than Viton A. It should be noted that not all THV polymer is elastomeric. The range of compositions with elastomeric character are summarized in “Modern Fluoropolymers”, J. Scheirs, ed, pp. 72-73, Wiley, New York, 1997.

Perfluorinated elastomers are also suitable for use with the present invention. Such perfluorinated elastomers are produced by the copolymerization of tetrafluoroethylene (TFE) and perfluoro(methyl vinyl ether) also described in Ullmann's, supra. Such perfluorinated elastomers are sold under the trademark Kalrez® Elastomers by DuPont Performance Elastomers. Another type of elastomer suitable for use with the present invention is a tetrafluoroethylene-propylene elastomer. TFE/propylene elastomers are sold under the trademark VITON® VTX by DuPont Performance Elastomers.

The amount of polymeric dispersing agent necessary to provide beneficial effect in the foamed article will generally be about 0.1 to 5 wt %, depending on the amount of char-forming agent that is present in the composition. Preferably the amount of such polymeric dispersing agent present is about 0.5 to 3 wt %, based on the total weight of the perfluoropolymer, char-forming agent and polymeric dispersing agent.

In another embodiment of the present invention, the foamed article further comprises an inorganic phosphor in an effective amount to color said foamed article when subjected to excitation radiation. The phosphor also similarly colors the article made from the composition so that the manufacturing source of the composition from which the article is made is detectable. U.S. Pat. No. 5,888,424 discloses the incorporation of inorganic phosphor into colorant-free fluoroplastics in very small amounts, up to 450 ppm. The phosphor typically comprises an inorganic salt or oxide plus an activator, the combination of which is sensitive to exposure to radiation in the 200-400 nm wavelength region causing fluorescence in the visible or infrared wavelength region. This fluorescence, constituting emitted radiation, gives a colored appearance to the composition or article made therefrom, which is characteristic of the phosphor. The phosphors disclosed in the '424 patent are useful in the present invention, except that a greater amount is required for the colored appearance to be seen. Thus, in accordance with this embodiment of the present invention, the amount of phosphor is about 0.1 to 5 wt %, preferably about 0.5 to 2 wt %, based on the combined weight of perfluoropolymer, char-forming inorganic agent, polymeric dispersing agent and phosphor. By way of example, the composition of Example 2 is supplemented with 0.5 to 1 wt % of ZnS/Cu:Al phosphor by dry mixing of the phosphor with the other jacket ingredients prior to extrusion, and the resultant jacket when subjected to ultraviolet light of 365 nm wavelength, gives a green appearance to the jacket in the visible wavelength region. When the ultra-violet light source is turned off, the jacket returns to its original white appearance. It will be noted that the phosphor of phosphor/activator combination no. 30 of Table 1 of the '424 patent includes ZnO, which is the inorganic char-forming agent in the aforesaid Example 2. When this particular char-forming agent is used, an activator such as the Zn of Example 30 of the '424 patent is all that need be added to the composition of the present invention to obtain a similar phosphor effect, i.e. fluorescence to produce a green color. Thus, in another embodiment of the present invention, when the char-forming inorganic agent has the ability to become a phosphor when suitably activated, an effective amount of such activator is added to the composition to produce the phosphor effect.

The foamed article can be in the form of a melt-fabricated article of the present invention, such as the jacket of data transmission cable. The foamed article of the present invention will typically be the result of two melt-processing treatments. First, the components are preferably melt blended, such as by using a twin-screw extruder or a Buss Kneader® compounding machine, to form molding pellets, each containing all three ingredients. The molding pellets are a convenient form for feeding to melt processing equipment such as for extruding the ingredients into the desired form of the foamed article, such as jacket for (on) twisted pair cable. The Buss Kneader® operates by melting the polymer components of the foamed article and shearing the molten composition to obtain the incorporation of the char-forming agent into the perfluoropolymer with the aid of the polymeric dispersing agent. The residence time of the composition in this type of melt processing equipment may be longer than the residence time in extrusion equipment. To avoid degradation, the Buss Kneader® is operated at the lowest temperature possible consistent with good blending, barely above the melting temperature of the perfluoropolymer, while the extrusion temperature can be considerably higher, because of its shorter residence time. Other additives that do not contribute to flammability or smoke in the NFPA-255 burn test, such as pigment, can also be compounded into the foamed article of the present invention.

The foamed article of the present invention is especially useful in the form of the jacket of plenum cable, to enable such cable to pass the NFPA-255 burn test. The most common such cable will contain four twisted pairs of insulated wires, but the jacket can also be applied to form cable of many more twisted pairs of insulated wires, e.g. 25 twisted pairs, and even cable containing more than 100 twisted pairs. It is preferred that the wire insulation of the twisted pairs be also made of perfluoropolymer. It has been found that when the entire wire insulation is replaced by polyolefin, the jacketed cable fails the NFPA-255 burn test.

The foamed articles of the present invention may be in forms other than cable, these articles too passing the NFPA-255 burn test. Examples of such articles include tubing, especially conduit (raceways) for data and voice transmission cable, profiles (spacers) for twisted pair cables, and tape for bundling cables.

Foamed articles according to the present invention have a reduction in density of greater than about 10% as compared to an unfoamed article. That is the density of the foamed article divided by the density of the unfoamed article is less than about 0.9. Preferably, the reduction is about 15% to 20%, more preferably up to about 30% reduction in density.

The foamed article according to the present invention is extruded in the presence of a foaming agent. The foaming of the article is obtained as a result thereof. The foaming agent may be a chemical blowing agent that is incorporated in the composition that decomposes to form a gas at the extrusion temperature. It may be mixed in as a powder and dry blended. This dry blended composition is then introduced into the extruder, where it melts. The chemical blowing agent then degrades, which degradation produces gas, typically carbon dioxide and nitrogen. Alternatively, the foaming agent may be injected into the extruder. Preferably, the foaming agent is a gas (also known as a physical foaming agent) preferably an inert gas such as nitrogen, carbon dioxide, or fluorocarbon, preferably nitrogen or carbon dioxide. Alternatively, it may be water which is gaseous at the foaming temperature. Such agents are injected into the extruder during melt processing of the composition used to make the foamed article. Typical conditions for foaming fluoropolymer compositions can be found in U.S. Pat. No. 5,032,621. It should be noted however, that no foam nucleating agent is needed to make foamed articles according to this invention, it being a surprising benefit that the large amount of filler in the composition not only does not hinder formation of a good foam in the article, but that it makes use of foam nucleating agent unnecessary.

### EXAMPLES

### Example 1

### Foamed Composition with Chemical Blowing Agent

The FEP used has an MFR of 28 g/10 min and contains PEVE comonomer as described in U.S. Pat. No. 5,677,404. The following composition: FEP 100 parts, aromatic hydrocarbon elastomer (Kraton® G1651, Kraton Polymers, Houston Tex. USA) 1 part per hundred parts FEP (pph), and 66.66 pph Kadox® 930 ZnO (Zinc Corporation of America, Monaca Pa. USA) (mean particle size of 0.33 μm (total weight of composition is 176.66 parts), is formed by melt mixing and then pelletized. This is the pelletized composition. Ficel® AFA powder (Bayer AG, Leverkusen, Germany) (0.5% and 1.0%) is dry blended with the pellets. This is identified as the blend. The blend is fed to a Haake one inch single-screw extruder heated to 350° C. at either 50 rpm or 100 rpm (see Table). A strand is extruded through a circular die, quenched in cold water, and dried. The density of the extrudate is measured and compared with the density of the composition that has not been foamed (2.8 g/cc). Void content (%)=(1−(density of foamed extrudate/2.8 g/cc))×100. Results are summarized in Table 1.

TABLE 1

| Sample | Ficel ® (wt %) | Temp (C.) | RPM | Void Content (%) |
|---|---|---|---|---|
| 1 | 0.5 | 350 | 50 | 44.2 |
| 2 | 0.5 | 350 | 30 | 40.9 |
| 3 | 1 | 350 | 30 | 47.6 |

Example 1 shows that foamed articles can be made from the composition using a chemical blowing agent. Foam nucleating agents are not needed.

### Examples 2 to 11

### Foamed Composition with Gas Injection

Nine parts of the pelletized composition of Example 1 are blended with one part of FEP containing 2.5 wt % boron nitride (Grade SHP-325, Carborundum, Saint-Gobain Advanced Ceramics of Amherst, N.Y., USA) and 1100 ppm calcium tetraborate (foaming package). This combination is extruded in Examples 1-4. The ratio of pelletized composition to foaming package is changed to 8:2 for Examples 5-7. Pelletized composition alone (no foaming package) is used for Examples 8-10.

A one-inch Davis-Standard single screw extruder is fitted with a general purpose screw (3:1 compression ratio) grooved to accept nitrogen gas injection, and a 0.747 in (19 mm) tubing die having a 0.375 in (9.5 mm) tip. Thermocouples measure four zones on the extruder and four zones on the die, the final thermocouple measures the melt temperature. Initial settings are (all temperatures in Celsius):

| Extruder Zones 1/2/3/4 | Die Zones 1/2/3/4 | Melt |
|---|---|---|
| 277/282/288/293 | 299/299/299/299 | 305 |

Nitrogen gas is metered into the extruder through a valve that has a flow of 107 cc/min at 2000 psi (13.8 MPa).
Example 2, nitrogen 107 cc/min @ 2500 psi (17.2 MPa), screw speed 5.6 rpm take up 1.35 ft/min (41 cm/min).
Example 3, nitrogen pressure to 2200 psi (15.2 MPa), screw speed 10 rpm in this and following Examples, take up 1.35 ft/min (41 cm/min).
Example 4, nitrogen pressure to 4000 psi (27.6 MPa), take up 1.5 ft/min (46 cm/min).
Example 5, nitrogen pressure to 2000 psi (13.8 MPa), take up 1.35 ft/min.
Eight parts by weight of Blend 1 is mixed with two parts of the pelletized composition and used in the following Examples:
Example 6, nitrogen pressure to 2000 psi (13.8 MPa), take up 1.35 ft/min (41 cm/min).
Example 7, nitrogen pressure to 4000 psi (27.6 MPa) take up 1.35 ft/min (41 cm/min).

The gas valve is changed to one that delivers 625 cc/min at a nitrogen pressure of 2000 psi (13.8 MPa).

Example 8, nitrogen pressure 2000 psi (13.8 MPa), take up 1.35 ft/min (41 cm/min).

Extruder and die temperatures are changed:

| Extruder Zones 1/2/3/4 | Die Zones 1/2/3/4 | Melt |
|---|---|---|
| 304/310/316/321 | 327/327/327/327 | 332 |

The pelletized composition alone is used.
Example 9, nitrogen pressure 2000 psi (13.8 MPa), take up 1.35 ft/min (41 cm/min).
Example 10, nitrogen pressure to 1000 psi (6.9 MPa), take up 1.35 ft/min (41 cm/min).
Example 11, nitrogen turned off, take up 1.35 ft/min (41 cm/min).

The results of the void measurements for the extruded tubing of the above Examples are summarized in Table 2.

TABLE 2

| | Example No. | | | | | | | | | |
|---|---|---|---|---|---|---|---|---|---|---|
| | 2 | 3 | 4 | 5 | 6 | 7 | 8 | 9 | 10 | 11 |
| Void content (%) | 36 | 1.8 | 27 | 2.2 | 23 | 24 | 24 | 16 | 15 | 13 |

Examples 2-11 show that foaming with nitrogen can be done effectively either in the presence of foam nucleating agents, or without them. It is further seen that effective foaming is possible without the use of nitrogen when extrusion is done at sufficiently high temperature.

### Example 3

Example 1 is repeated except that in place of the hydrocarbon polymer dispersing agent, Kraton®, Viton® VTX is used. This composition extrudes well to give uniformly foamed strands having void contents similar to those seen in Example 1.

### Example 4

A jacket of the melt blended composition is formed by extruding the blend Example 1 as a jacket over a core of four twisted pairs of FEP-insulated wires to form jacketed cable, using the following extrusion conditions: The extruder has a 60 mm diameter barrel, 30:1 L/D, and is equipped with a metering type of screw having a compression ratio with the respect to the barrel of about 3:1 as between the feed section of the screw and the metering section, i.e. the free volume, that is the volume in the extruder barrel that is unoccupied by the screw, within the screw flights in the feed section are about 3× the volume within the screw flights within the metering section. For a screw of constant pitch, the compression ratio is the ratio of the flight depth in the feed section to the flight depth in the metering section (metering into the crosshead). The application of heat to the extruder barrel starts with 530° F. (277° C.) in the feed section, increasing to 560° F. (293° C.) in the transition section and then to 570° F. (298° C.) in the metering section. The extruder is fitted with a B&H 75 crosshead. The assemblage of four twisted pairs of FEP-insulated wires is fed though the crosshead and out the die tip of the crosshead. The temperature of the molten fluoropolymer at the die surrounding the die tip is 598° F. (314° C.). The outer diameter of the die tip is 0.483 in (12.3 mm) and the inner diameter of the die is 0.587 in (14.7 mm), with the annular space between the die tip and the I.D. of the die forming the annular space through which a molten tube of FEP is extruded and drawn down to coat the assemblage of twisted pairs of insulated wire. No vacuum is used to draw the extruded tube down onto the core of twisted pairs of insulated wires. The draw down ratio is 10:1, the thickness of the jacket being 10 mils, and the draw ratio balance is 0.99. The line speed is 403 ft/min (123 m/min).

The resulting insulated wire is subjected to the NFPA-255 burn test and passes that test.

What is claimed is:

1. A foamed, melt-fabricated article containing a composition comprising perfluoropolymer, about 10-60 wt % char-forming inorganic agent, and an effective amount of polymeric dispersing agent to disperse the char-forming inorganic agent in the perfluoropolymer during melt processing.

2. The article of claim 1, wherein the polymeric dispersing agent comprises about 0.1 to 5 wt % hydrocarbon polymer that is thermally stable at the melting temperature of said perfluoropolymer, to total 100 wt % based on the combined weight of said perfluoropolymer, agent and hydrocarbon polymer.

3. The article of claim 1, wherein the polymeric dispersing agent comprises 0.1 to 5 wt % fluoropolymer additive, to total 100 wt % based on the combined weight.

4. The article of claim 3, wherein the fluoropolymer additive is selected from the group consisting of vinylidene fluoride/hexafluoropropylene (VF2/HFP) copolymer, tetrafluoroethylene/propylene (TFE/propylene) copolymer, vinylidene fluoride/hexafluoropropene (VF2/HFP/TFE) copolymer and tetrafluoroethylene/perfluoro(methyl vinyl ether) (TFE/PMVE) copolymer.

5. The article of claim 1, wherein the article has a reduction in density of greater than 10% as compared to the unfoamed article.

6. The article of claims 2 or 3, which passes the NFPA-255 burn test.

7. A melt fabricated article of claim 1, wherein said article comprises a cable jacket, tubing, profiles or tape.

8. The article of claim 1 wherein said agent is in the form of particles having a mean particle size of no greater than about 3 micrometer.

9. The article of claim 1 wherein said agent is metal oxide.

10. The article of claim 9 wherein said metal oxide is ZnO.

11. The composition of claim 2 wherein said hydrocarbon polymer is thermoplastic elastomer.

12. The article of claim 11 wherein said thermoplastic elastomer contains aromatic moiety.

13. The article of claim 2 wherein said composition is free of added antioxidant.

14. The article of claim 2 or 3 further comprising an inorganic phosphor in an effective amount to color said composition when subjected to excitation radiation.

15. The article of claims 2 or 3 wherein said char-forming agent is ceramic microspheres.

16. The article of claims 2 or 3 wherein the composition further includes a chemical blowing agent.

17. A process for foaming the article of claim 1, comprising extruding the article in the presence of a foaming agent and obtaining as a result thereof said foaming of said article.

18. The process of claim 17, wherein the foaming agent is a chemical blowing agent incorporated in the composition that decomposes to form a gas at the extrusion temperature.

19. The process of claim 18, wherein the foaming agent is injected into the extruder.

20. The process of claim 17, wherein said extruding the article is done in the absence of a nucleating agent.
